(19) United States
(12) Patent Application Publication
(10) Pub. No.: US 2016/0097868 A1
(43) Pub. Date: Apr. 7, 2016

(54) RADIATION SURVEYING

(71) Applicant: Source Production & Equipment Co., Inc., St. Rose, LA (US)

(72) Inventor: Richard Donald Dicharry, Slidell, LA (US)

(21) Appl. No.: 14/872,755

(22) Filed: Oct. 1, 2015

Related U.S. Application Data
(60) Provisional application No. 62/058,804, filed on Oct. 2, 2014.

(51) Int. Cl. G01T 7/00

(52) U.S. Cl. CPC G01T 7/00

(57) ABSTRACT

In order to improve the compliance of proper radiography surveys, and to overcome the myriad of human factor and other reasons that may cause an operator—consciously or unconsciously—to not make a survey, the system described herein may serve to transform the survey process from a totally active effort to a largely passive one. The system described herein is active, thus allowing the operator to be more passive in connection with performance of radiation surveys. In concept, according to the system described herein, surveying radiographic equipment and general areas is transformed from the requirement to attentively move an instrument through space while observing a meter panel. Instead, the system described herein enables a process whereby the operator may perform other (non-survey) activities while the survey occurs automatically and provides the results directly to the operator without requiring the operator to make independent, active efforts.

### RELATED APPLICATIONS

This application claims the benefit of U.S. Provisional App. No. 62/058,804 filed Oct. 2, 2014, entitled “Radiation Survey Device,” which is incorporated herein by reference.

### TECHNICAL FIELD

This application relates to the field of radiation surveying, and more particularly to the field of radiation surveying using a passive system.

### BACKGROUND OF THE INVENTION

Industrial radiography is the use of ionizing radiation to view the interior of an object that cannot otherwise be seen. It is a method of inspecting materials for hidden flaws by using the ability of high energy radiation to penetrate various materials.

In radiography, a source of penetrating photon radiation (X-ray or gamma ray) is placed on one side of a specimen to be examined and a radiation sensitive material (often film, but many types of materials may be used) is placed on the other side. In passing through the specimen, the radiation is attenuated by the material along the beam path. Thicker and denser material will attenuate the radiation to a greater degree than thinner and less dense material. Therefore, when a source of radiation is placed at a distance from the object to be examined, the radiation is used to produce a spatial image of the thickness and density variations along all of the beam paths through the object.

The first radiographs were made in 1895 with the discovery of X-rays by Wilhelm Conrad Röntgen, a German physicist. X-rays are produced when high energy electrons collide with a metal target within a vacuum. The electrons are energized by accelerating them through a high voltage electric field. In most X-ray systems, the target is made from Tungsten, although other target materials, such as molybdenum, may also be used.

The penetrability of the photon radiation is dependent upon the energy of the photon. Lower energy photons will be more highly attenuated (and therefore penetrate less) than higher energy photons. Therefore, for radiographic examination of thick specimens of dense material, high energy photons are required.

Normal X-ray generators are limited in the energy that can be produced because of limitations in the voltage that can practicably be applied to the X-ray tube. Furthermore, a typical X-ray machine is large and requires a power source, it cannot be taken to remote locations without significant expense.

However, radioisotope sources can have far higher photon energies than could be obtained from normal X-ray generators. Radioisotope sources also have the advantage of not requiring an external power source. Therefore, industrial radiography performed with gamma emitting radionuclides is very portable. The radioactive source can be transported to remote locations, for example along pipelines, to perform radiography that would be extremely impracticable with X-ray sources.

Gamma radiation sources, most commonly ¹⁹²Iridium and ⁶⁰Cobalt, but also ⁷⁵Selenium, ¹⁷⁰Thulium and ¹⁶⁹Ytterbium, are used to inspect a variety of materials. The vast majority of gamma radiography concerns the testing and welds on piping, pressure vessels, storage containers, pipelines, and structures. Tested materials include steel and many other metals, but also concrete (locating rebar or conduit), and ceramics (used in the aerospace industry). Theoretically, industrial gamma radiography can be applied to any solid, flat material (walls, ceilings, floors, square or rectangular containers) or any hollow cylindrical or spherical object.

As gamma radiography sources require no power, they are always emitting radiation. They cannot be “turned off”. The sources used for industrial gamma radiography are high activity and emit very high radiation exposure rates, sufficient to cause physiological injury to a person who places a body part in the close vicinity to such sources for only a short period of time. Therefore, these sources must be handled with great care.

As a result of this inability to “turn off” the radiation source, it is important for the operator to always know the radiation dose rate he is receiving and where the radiation source is located (i.e. in the shielded container, in the source guide tube, in the exposure position, within a collimator, etc.). As the radiation cannot be sensed by any of the human senses, at least in the short term and with limited exposures, then this knowledge of the radiation dose rate to which the operator is being exposed is usually accomplished through the use of a hand-held radiation survey meter.

The traditional radiation survey meter contains a radiation detector and its associated electronics and displays the results of the radiation exposure level that the detector is experiencing on a meter panel on the surface of the survey meter. This generally takes the form of a rectangular box, of a few centimeters on a side. The radiation detector may be a Geiger-Müller tube or an ionization chamber, but could be a solid state detector (scintillating crystal, diode) or a wide variety of detectors.

The operator traditionally uses this hand-held radiation survey meter to measure the ambient radiation exposure rates by moving the instrument through space and observing the resultant measured values on the display panel of the instrument. The operator would use this instrument to assure that the radioactive source was in the shielded container by moving the survey meter over the entire surface of the shielded container, with particular interest in the exit port, to assure that the radiation exposure levels were those which would be expected from a shielded source. The operator would then move the survey meter along the source guide tube away from the shielded container to observe that the radiation intensity reduced quickly as the distance from the shielded container increased. The operator would continue to move the radiation survey instrument along the entire length of the source guide tube, to the exposing position, to assure that the radiation levels at those locations are nearly nonexistent.

During a radiographic operation, the operator would monitor the radiation exposure rates at the boundaries of the controlled areas to assure that these boundaries were properly established.

In case of an emergency, the operator would use the radiation survey instrument to assess the extent of the radiation hazard and establish proper restricted areas to protect the general public.

These practices are well established and are codified in many national and state regulations and also in many codes of practice for the performance of industrial radiography. Additionally, they are well described in many text books and safety manuals for industrial radiographic operators.

Nonetheless, accidental radiation overexposures occur in industrial radiography and the primary cause of the vast majority of these overexposures is the failure of the operator to make a proper radiation survey.

Although radiographic operators are trained in the proper use of survey instruments and their performance is periodically audited, accidents still occur. In many cases, inattention to the required details, distractions, conscious disregard of the requirement in order to expedite the production, overtiredness, and a myriad of other human factor excuses/reasons exist. The end result is that these required surveys are sometimes not performed or are not performed properly.

In some cases, an operator may wear a passive “back-up” radiation detection device to supplement the hand-held radiation survey instrument. The back-up detection device may be a real time rate meter that is worn on the body of the operator and emits an audio alarm when the back-up detection device is exposed to dangerous levels of radiation. However, if the back-up detection device is defective or if the batteries are not present or charged, the real time rate meter is silent in the presence of dangerous radiation, which an operator may misinterpret as indicating that radiation levels are not dangerous. Note also that the back-up detection device is worn on one part of the operator (e.g., the hip) may not sufficiently detect dangerous radiation exposed at another part of the operator (e.g., the hands). Generally, the improper use of radiation survey instrument, and/or the intentional failure to perform a survey with a hand-held radiation survey instrument and/or a defective, inoperative, and/or misinterpreted alarming ratemeter sometimes result in overexposures to the operator(s) and possibly even other members of the public.

Accordingly, it would be desirable to provide a system to overcome the manifest deficiencies in the current state of the art in connection with features and functions of radiation surveying and to enhance radiation safety for the operator and the general public.

### SUMMARY OF THE INVENTION

According to the system described herein, a radiation survey system includes a radiation detector that measures radiation substantially continuously. A control unit receives data from the radiation detector and processes the data. A display device receives the processed data from the control unit and displays the processed data on a display substantially continuously to show radiation levels fluctuating within a normal range as the radiation detector is moved to different areas. The display device is wearable or carryable by an operator. The radiation detector and/or the control unit may be wearable or carryable by the operator. The control unit and the display device may be combined into a single control/display unit, and the single control display unit may be wearable on a head or a wrist of the operator. The radiation detector, the control unit and the display device may be integrated into a single integrated unit, and the single integrated unit may be wearable on a head or a wrist of the operator. The radiation detector may be wearable on an arm, leg, wrist, ankle, or finger of an operator. The system may further include a radiation emitting unit that emits the radiation detected by the radiation detector, and may include an exposure device that is controllable by the control unit. The operator is presented with radiation information by the display device without the operator actively performing independent radiation survey actions. The system may further include a remote site that receives control information from the radiation detector, where radiation detectable at the radiation detector is not directly detectable at the remote site. The system may further include one or more of the following: the radiation detector may a first radiation detector, and the radiation survey system may further comprise at least one second radiation detector; the control unit may be a first control unit, and the radiation survey system may further comprise at least one second control unit; or the display device may be a first display device, and the radiation survey system may further comprise at least one second display device.

According further to the system described herein, a method of performing a radiation survey includes disposing a radiation detector at a position on an operator. Radiation is measuring at the radiation detector substantially continuously. At a control unit, data is received that is sent from the radiation detector. The received data is processed at the control unit. At a display device, the processed data is received that is sent from the control unit. The processed data is displayed to an operator on a display of the display unit substantially continuously to show radiation levels fluctuating within a normal range as the radiation detector is moved to different areas, and in which the display unit is worn or carried by the operator. The radiation detector and/or the control unit may be worn or carried by the operator. The control unit and the display device may be combined into a single control/display unit, and the single control display unit may be worn on a head or a wrist of the operator. The radiation detector, the control unit and the display device may be integrated into a single integrated unit, and the single integrated unit may be worn on a head or a wrist of the operator. The radiation detector may be wearable on an arm, leg, wrist, ankle, or finger of an operator. A remote site may receive control information from the radiation detector, where radiation detectable at the radiation detector is not directly detectable at the remote site. Radiation emitted by a radiation emitting unit may be detected at the radiation detector. The radiation emitting unit may include an exposure device that is controlled by the control unit. The operator may be presented with radiation information on the display of the display device without the operator actively performing independent radiation survey actions.

The system described herein may replace a hand-held survey meter (instrument) and may replace a direct reading dosimeter (“pocket dosimeter, pocket chamber or electronic personal dosimeter”) that would otherwise be worn on the trunk of the operator's body to record accumulated radiation “whole-body” dose over the period of a work shift or day. The system described herein may also replace an operating alarm ratemeter that would otherwise be worn on the trunk of the operator's body to provide an alarm signal to the operator at a dose rate of 5 mSv/hr (500 mrem/hr) or higher. The system described herein may also replace a personal dosimeter (film badge or electronic personal dosimeter) that would otherwise be worn on the trunk of the operator's body to record accumulated radiation dose for a period of a month, quarter and year and is processed and evaluated by an accredited National Voluntary Laboratory Accreditation Program (NVLAP) processor. This may be accomplished by incorporating a personal dosimeter (film badge or electronic personal dosimeter) into the control unit, as long as the personal dosimeter is worn on the trunk of the body of the operator, and is able to be detached from the control unit and sent for processing, or, instead, the control unit/personal dosimeter may be sent to a NVLAP to process the personal dosimeter. The system described herein may also allow the operator to monitor a radiation exposure rate at a restricted area boundary via use of one or more remote radiation detectors.

### BRIEF DESCRIPTION OF THE DRAWINGS

Embodiments of the system described herein will be explained in more detail below on the basis of the figures, which are briefly described as follows.

FIG. 1 is a schematic illustration of a radiation survey system according to an embodiment of the system described herein.

FIG. 2 is a schematic illustration showing remote transfer systems of a radiation survey system according to an embodiment of the system described herein.

FIG. 3 is a schematic illustration showing a radiation survey system including multiple radiation detectors according to an embodiment of the system described herein.

FIG. 4 is a schematic illustration showing an example configuration of a radiation survey system according to an embodiment of the system described herein.

FIG. 5 is a schematic illustration showing a radiation survey system according to an embodiment of the system described herein in which components of a radiation detector, a control unit and a display device are all incorporated into one integrated unit.

FIG. 6 is a flow diagram showing a method for displaying radiation information and/or alerts to an operator according to an embodiment of the system described herein.

### DETAILED DESCRIPTION OF VARIOUS EMBODIMENTS

In order to improve the compliance of proper radiography surveys, and to overcome the myriad of human factor and other reasons that may cause an operator—consciously or unconsciously—to not make a proper survey, the system described herein may serve to transform the survey process from a totally active effort to a largely passive one. The system described herein is active, thus allowing the operator to be essentially passive in connection with performance of radiation surveys. In concept, according to the system described herein, the process of radiographic surveying is transformed from the requirement to attentively move a survey instrument through space while observing a meter panel. Instead, the system described herein enables a process whereby the operator may perform other (non-survey) activities while the survey occurs automatically and provides the results directly to the operator without requiring the operator to make independent, active efforts. The system also provides continuous information to the operator regarding the proper operability status of the system.

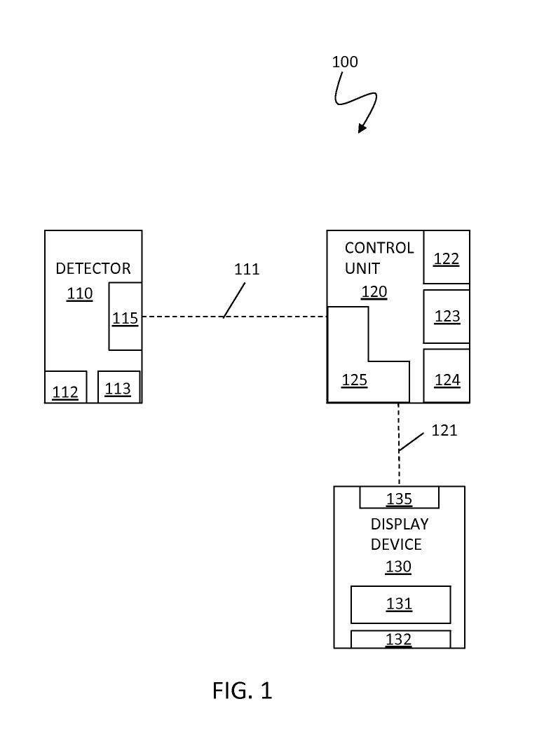

FIG. 1 is a schematic illustration of a radiation survey system 100 according to an embodiment of the system described herein that includes a radiation detector 110, a control unit 120 and a display device 130. The radiation detector 110 may be used to perform radiation exposure measurements in connection with the system described herein. In various embodiments, the radiation detector 110 may be separate from the rest of the system and/or may be integrated into one or more other system components, such as the control unit 120, discussed elsewhere herein. The radiation detector 110 may be small and may be attached to a part of the body of the operator and/or otherwise worn by the operator. The radiation detector 110 may be worn on the belt or pocket of clothing, on the arm or leg, on the wrist (e.g., as a wristwatch) or ankle and/or on a finger (e.g., as a ring), among other possible locations, as further discussed elsewhere herein. In some embodiments, the radiation detector 110 may be placed in a remote location away from the operator. An operator may wear multiple detectors. In some instances, one of the detectors may be designated as a “primary” detector and the other detectors may possibly be designated as “secondary” detectors. The detector 110 may be powered either by a power source 112, such as a self-contained power source (e.g., battery), and/or by a hard wired power source, and/or by a wireless power supply such as provided through an inductive coupling. The radiation detector 110 may measure the radiation exposure rate levels at the detector and transmit these measurements, using a transmitter 115, to a receiver/processor/control unit 120 either through a wired connection and/or a wireless connection, such as Bluetooth technology, and illustrated schematically as connection 111. In other embodiments, the detector 110 may also include other computing or electronic components such are illustrated schematically as components 113.

In this way, the radiation exposure rates are measured in the proximity of the operator, that is wherever the radiation detector 110 is worn on the operator (e.g., body, arm, leg, wrist, ankle, and/or finger, etc.) and/or wherever then placed by the operator to perform radiation exposure measurements. As the operator moves the radiographic system, operates the controls, and/or positions the source guide tube or collimator, the radiation exposure rates are measured using the radiation detector 110. In an embodiment, the system may contain multiple radiation detectors each supplying radiation exposure rate information and/or accumulated radiation dose data from a different location on the operator's body, and/or from a remote location away from the operator, as further discussed elsewhere herein.

The control unit 120 for the system described herein may also be carried and/or otherwise present on the operator's body (i.e., worn on the body of the operator using a belt, pocket, etc.). In an embodiment, the control unit 120 be may be separate from the radiation detector 110, but, in other embodiments, the control unit 120 may also be integrated with the radiation detector 110 and/or with the display device 130. The control unit 120 may include a transmitter-receiver 125 to receive data from the radiation detector 110 and to transmit processed data, as further discussed elsewhere herein. In an embodiment, the control unit 120 may be sized to be carried, such as sized like that of a mobile phone, and have the capabilities of a computer with the ability to receive radiation exposure rate data from the radiation detector 110, process this data, and transmit the processed data to the display device 130 and/or other device(s). The control unit 120 may also be implemented as a mobile phone that has an application (app) and/or appropriate hardware to accomplish these functions.

In other embodiments, the control unit 120 may be a wearable device, including smart glasses such as Google Glass and/or other type of wearable device. The control unit 120 may be integrated into the display device 130. In various embodiments, the control unit 120 may also accept visual/video data from a source (e.g., a camera mounted on the operator's body and/or incorporated into the wearable display device itself) and/or accept audio data from a separate source (e.g., a microphone mounted on the operator's body and/or incorporated into the wearable device itself) and also send at least a portion of this visual/audio data to the display device 130 for display thereon. In some embodiments, there may be multiple display devices.

The control unit 120 may include at least one processor 122 to perform various types of data processing functions and may include on-board memory 123 to maintain data storage and record-keeping. The control unit 120 may be powered either by power source 124, including a self-contained power source (battery), a hard wired power source and/or by a wireless power supply such as provided through an inductive coupling. The control unit 120 may compute radiation exposure rate values from the input by the radiation detector 110. The control unit 120 may combine radiation exposure rate values with data from an on-board clock to compute integrated (accumulated) radiation dose values, including over short periods of time (e.g., during individual operations) and well as over long periods of time (e.g., hourly, daily, weekly, monthly, quarterly, annual exposure). Using the transmitter-receiver 125, the control unit 120 may transmit selected processed data to the display device 130 either through a wired connection or a wireless connection (such as Bluetooth technology), as further discussed elsewhere herein and illustrated schematically as connection 121.

In an embodiment, the control unit 120 may combine radiation exposure rate values and integrated (accumulated) radiation dose values with data from received GPS data to permit evaluation of the spatial locations where radiation exposure is received. The control unit 120 may combine radiation exposure rate values and integrated (accumulated) radiation dose values with visual/video data to permit evaluation of the spatial locations where radiation exposure is received. The control unit 120 may combine radiation exposure rate values and integrated (accumulated) exposure values with audio data to permit evaluation of the circumstances under which radiation exposure is received.

In another embodiment, the control unit 120 may contain software, stored in the at least one memory 123 of the control unit 120 and executable by at least one processor 122, to convert audio data to text. This control software may include the ability to act upon audio commands (for example: “Display Exposure Rate”; or “Display Accumulated Exposure”; or “Signal Supervisor for Assistance”; or “Signal Radiation Safety Officer”). The control unit 120 may compare radiation exposure rates to preset thresholds and transmit warnings, either visual, audible, tactile (vibratory or other) if threshold values are exceeded.

In another embodiment, the control unit 120 may include a radiation detector. This radiation detector may be provided as the radiation detector 110 discussed elsewhere herein and/or may be an additional radiation detector in addition to the radiation detector 110.

The display device 130 for the system 100 may be separate from, and/or integrated with, the detector 110 and/or the control unit 120. The display 130 may also be carried or worn on the operator's body, including possibly the head of the operator. The display device 130 may include a receiver 135 with the ability to receive data from the control unit 120, and a display 131 to visually present this data to the operator and possibly others in the case of a remote system in one or several forms, as further discussed elsewhere herein. The display device 130 may also include other computing or electronic components shown schematically as components 132.

In an embodiment, the display device 130 may be a wearable computer monitor/display device. For example, the display may be face/head-mounted display, such as Google Glass or other type of wearable display device. The display device 130 may provide a continuous display of the data received and processed by the control unit 120, with refresh rates determined by the operator and/or configured as part of the system. The display device 130 may be integrated with the control unit 120 and/or may be separate from the control unit 120. In principle, as the operator approaches a radiography exposure device with his hands reaching toward the locking mechanism, the display device 130, e.g. as a head mounted visual display, may visually provide real time radiation exposure rate data measured by the radiation detector on his extremity (e.g., hand, finger and/or wrist) and processed by the control unit 120. In this way, the operator may be passively presented with exposure rate and integrated (accumulated) exposure data without the need for actively making a radiation survey.

The information presented to the operator using the radiation survey system 100 may include radiation exposure rate values, integrated (accumulated) radiation dose values, including over short periods of time (e.g., during individual operations) and well as over long periods of time (e.g., hourly, daily, weekly, monthly, quarterly, annual exposure) as measured by the detector 110, processed by the control unit 120 and displayed on the display device 130.

In addition to the radiation exposure data processed by the control unit 120, the display device 130 may also present a visual indication that all systems are working and responding to radiation (e.g., a blinking character or symbol). Further, the display device 130 may provide real time warning if the present radiation exposure rate exceeds a pre-set threshold, or if integrated (accumulated) radiation dose values exceed preset thresholds as calculated by the control unit 120. In various embodiments, the real time warnings may be visual, audible or even tactile warnings, for example, vibration. The display device 130 may also present basic operational information, such as a battery/power indication. In another embodiment, the display device 130 may incorporate video and/or audio recording device(s) and that may be used in the display on the display device 130 and/or transmitted to the control unit 120 for use thereby.

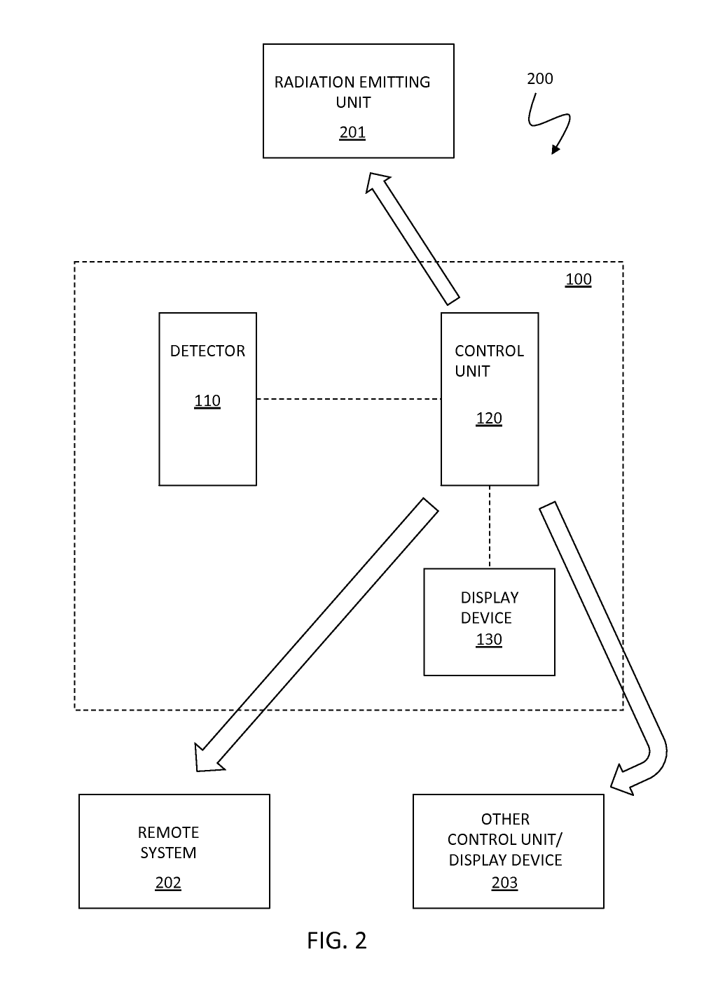

FIG. 2 is a schematic illustration showing remote transfer systems of a radiation survey system 200 according to an embodiment of the system described herein. In the illustrated radiation survey system 200, in addition to operations of the radiation survey system 100 discussed elsewhere herein, such as the transmission by the control unit 120 to the display device 130 of the operator, the control unit 120 may also transmit—wirelessly or by wired download—the processed and/or recorded data to a remote site 202 having a separate or remote computer system (e.g., on-board a radiography vehicle, at the radiography office, at other locations etc.) and/or to another control unit/display device 203 at other locations and/or being worn by another operator to permit supervisory personnel to monitor individual activities. The remote site 202 may be at a distance in which radiation detectable at the radiation detector 110 is not directly detectable at the remote site 202. Communication between the control unit 120 and the remote site 202 may be by any appropriate means, including cellular network, Internet, direct connection (wired or wireless), and/or some combination thereof with or without other communication technologies. In an embodiment herein, the remote site 202 may be part of a safety monitoring system that ensures compliance (e.g., that the operator is properly using the radiation detection device(s)).

Additionally, the control unit 120 may also transmit (wirelessly or by wired download) a signal to a radiation emitting unit 201 (e.g., radiography exposure device, brachytherapy delivery device, x-ray generator, etc.), as discussed elsewhere herein. In various embodiments, the radiation emitting unit 201 may then be configured according to the transmission from the control unit 120, such as by being configured to “lock out” the particular operator once the received radiation dose exceeds a pre-determined threshold value and/or by the radiation emitting unit 201 being operated to move the radiation source back into a shielded position within the radiation emitting unit 201, as further discussed elsewhere herein. Note also that a lock out may occur if it is determined at the remote site 202 that the operator is not properly wearing radiation detection devices(s).

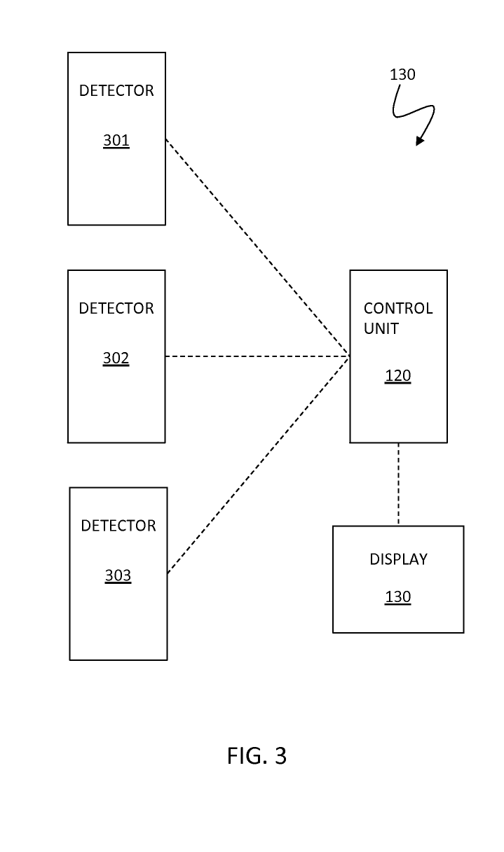

FIG. 3 is a schematic illustration showing a radiation survey system 300 including multiple radiation detectors 301, 302, 303 according to an embodiment of the system described herein. The radiation detectors 301, 302, 303 may all be similar to the radiation detector 110 discussed elsewhere herein and/or may include different types of radiation detectors. The radiation detectors 301, 302, 303 may transmit detected radiation information to the control unit 120 for processing, and processed data and/or other information may then be transmitted and displayed on the display device 130, as further discussed elsewhere herein. With the use of multiple radiation detectors 301, 302, 303, all of the individual exposure rate data, integrated (accumulated) radiation dose data, and other data, such as position (GPS) data, may be maintained separately (e.g., identifying finger, hand, ankle, body exposure independently) and/or may be combined at the control unit 120 using various algorithms for analysis purposes.

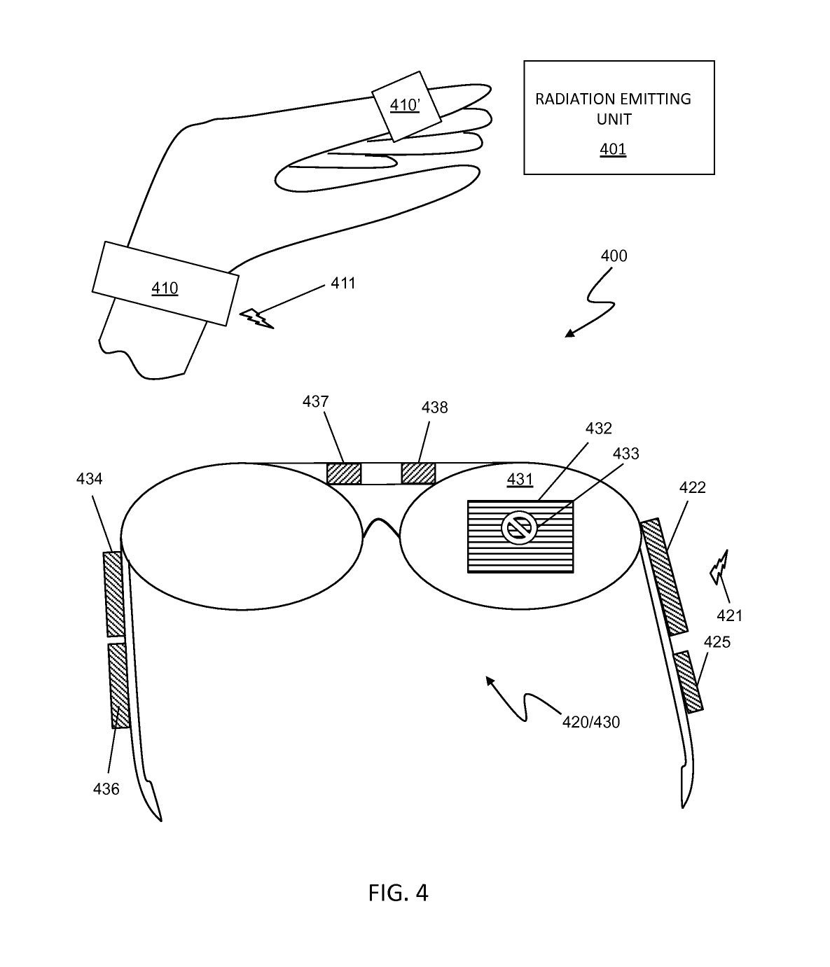

FIG. 4 is a schematic illustration showing an example configuration of a radiation survey system 400 according to an embodiment of the system described herein. A radiation detector 410 is shown positioned on a wrist of an operator and may have the features and functions like that of the radiation detector 110 discussed elsewhere herein. The radiation detector 410 may detect radiation received at the operator, for example, from a radiation emitting unit 401. An alternative radiation detector 410′ is shown as being worn on a finger of the operator. A combined control unit/display device 420/430 is shown configured to be worn on the head of the operator, and may include smart glasses, such as Google Glass and/or other appropriate type of wearable device. The combined control unit/display device 420/430 may have the features and functions like that of the control unit 120 and the display device 130 discussed elsewhere herein. In the illustrated embodiment, the radiation detector 410 measures radiation levels at the wrist of the operator and transmits radiation information wirelessly, shown as signal 411, to the combined control unit/display device 420/430.

The control unit/display device 420/430 may receive, using a transmitter-receiver or transceiver 425, the information received from the radiation detector 410. The information may then be processed by computing or electronic components 422, including at least one processor and memory, of the control unit/display device 420/430. Results of the processing may then be processed on a display 431 of the control unit/display device 420/430. The information 432 presented to the operator using display 431 may include radiation exposure rate values at the location of the radiation detector 410, and may include integrated (accumulated) radiation dose values, including over short periods of time (e.g., during individual operations) and well as over long periods of time (e.g., hourly, daily, weekly, monthly, quarterly, annual exposure), among other data and/or information. Note that generally, for the system described herein, radiation exposure rate values may be provided substantially continuously irrespective of whether the values have exceeded any pre-set threshold limits so that the operator has a continuous indication that the equipment is operational.

In addition to the radiation exposure information 432, the display 431 may also present a visual indication 433 (e.g., a status report) that may indicate all systems are working and responding to radiation and/or that may present a real time warning indication concerning exposure. The indicators may be presented as visual indicators (e.g., a blinking character or symbol), audible indicators (e.g., an alarm sound) or tactile (e.g. vibration of the control unit/display device 420/430). In an embodiment, the display 431 may provide the real time warning indication if the radiation exposure rate exceeds a pre-set threshold, or if integrated (accumulated) radiation dose values exceed preset thresholds as calculated by the at least one processor 422. As discussed, in other embodiments, the control unit/display device 420/430 may also include a speaker 434 to present audible warnings to the operator and/or may include vibration components 436 to alert the operator using vibration. The display 431 may also present basic operational information, such as a battery/power indication. The transceiver 423 of the control unit/display device 420/430 may further transmit a wireless signal 421 to another site or unit, as further discussed elsewhere herein, including to the radiation emitting unit 401 to enable control thereof.

In another embodiment, the control unit/display device 420/430 may also include one or more media units that may include a camera 437 and/or a microphone 438. The at least one processor of the computing or electronic components 422 may thereby accept visual/video data from the media units 437, 438, and the information 432 displayed on the display 433 may incorporate the video and/or audio information recorded by the media units 437, 438.

The features described in connection with the system 400 are discussed principally in connection with use of a face/head-mounted visual computer control unit/display device 420/430. In other embodiments, the system described herein may alternatively and/or additionally include use of a wrist-worn computer/display (e.g., such as a Garmin wrist GPS, Samsung watch, Apple watch and/or other appropriate type of wrist worn computer controlled display component) and/or by a device not worn but carried, such as a tablet or other type of mobile computer with a display that may be carried by an operator. As further discussed elsewhere herein, in various embodiments, the display device may be incorporated into the control unit and/or the display device may be separate from the control unit. For example, the control unit may be incorporated within a carried device, such as a tablet computer or mobile phone, while the operator wears a display on the head or wrist which receives transmissions from the control unit and displays the information to the operator. Additionally, the system described herein may include use of additional control units and/or display devices that are worn or carried by the operator, or used at remote locations, as further discussed elsewhere herein.

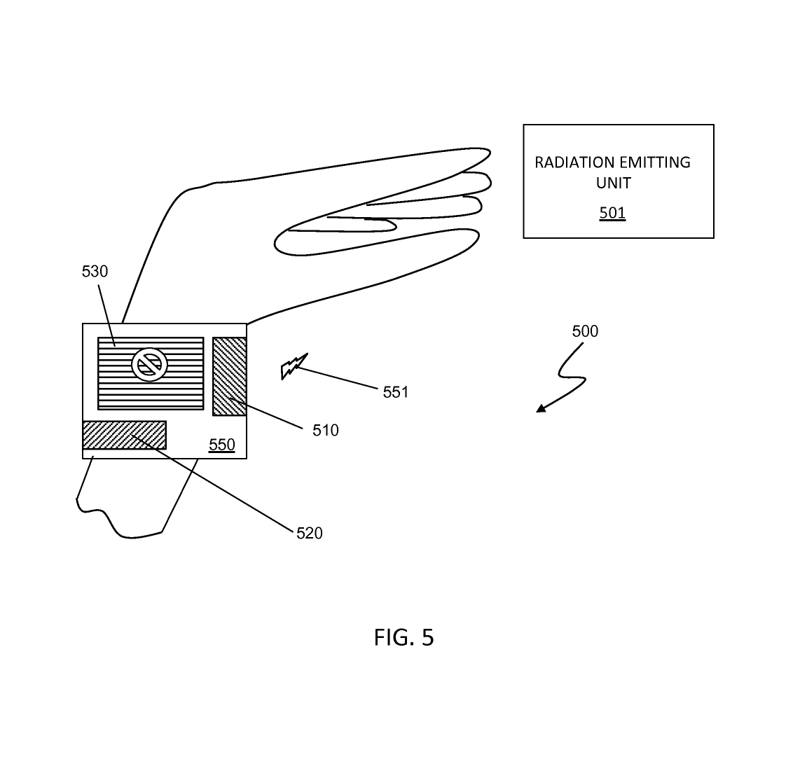

FIG. 5 is a schematic illustration showing a radiation survey system 500 according to an embodiment of the system described herein in which components of a radiation detector 510, a control unit 520 and a display device 530 are all incorporated into one integrated unit 550. In the illustrated embodiment, the integrated unit 550 is shown being worn on a wrist of an operator.

The radiation detector 510 may have features and functions like that discussed elsewhere herein and may detect radiation emitted from a radiation emitting unit 501. Similarly, the control unit 520 and the display device 530 may have features and functions like that discussed elsewhere herein. The integrated unit 550 advantageously provides for one device to be worn and maintained by the operator and facilitates alerting of an operator (e.g. visual, audible and/or tactile alerts) as to radiation information, and, specifically, in which the operator is not required to actively or independently initiate radiation survey actions. As illustrated, the integrated unit 550 may also transmit one or more wireless signals 551 to other units, such as to the display device, other control units and/or to the radiation emitting unit 501 to enable control thereof based on the radiation information received, processed and displayed at the integrated unit 550.

In an embodiment, the system described herein may be used in connection with the application of gamma-emitting radiation sources. More particularly, the system described herein may be used in connection with sources containing ¹⁹²Iridium, ⁶⁰Cobalt, ⁷⁵Selenium, ¹⁷⁰Thulium and/or ¹⁶⁹Ytterbium as the gamma radiation-emitting source and to methods of delivering these sources for temporary application. For discussions of gamma-emitting radiation sources that may be used in connection with the system described herein, reference is made to U.S. Pat. No. 8,357,316 B2 to Munro et al. entitled “Gamma Radiation Source” and to US Publication No. 2013/0009120 A1 to Munro et al. entitled “Radioactive Material Having Alterated Isotropic Composition,” which are incorporated herein by reference.

According to various embodiments of the system described herein, the system described herein may include radiation emitting units or equipment, for example, used for industrial radiography (e.g., non-destructive testing) and/or for medical purposes such as brachytherapy devices. In an embodiment, the radiation emitting unit may include an exposure device, for example, provided as a depleted uranium (DU) shielded, Category II (“crank-out”) exposure device. Besides the use of depleted uranium as shielding material, the system described herein may also be applied to tungsten or lead shielding material or any other dense material typically used for gamma radiation shielding, such as materials having a density greater than 6 g/cm³. For a discussion of shielded exposure devices that may be used in connection with brachytherapy devices and other applications, reference is made to US Publication No. 2014/0066687 A1 to Munro, entitled “Radiation Therapy of Protruding and/or Conformable Organs,” which is incorporated herein by reference. Note that it is important to ensure appropriate radiation levels when a patent is being moved into and out of a room either before or after treatment. In such a situation, it is possible for attendants to use the system described herein to ensure appropriate radiation levels in the room both before and after treatment.

Generally, the system described herein may be used in situations where it is useful to continuously monitor radiation levels at specific locations. The system may be used by workers in nuclear facilities, medical facilities, delivery drivers, workers at shipment facilities, workers in manufacturing facilities, etc.

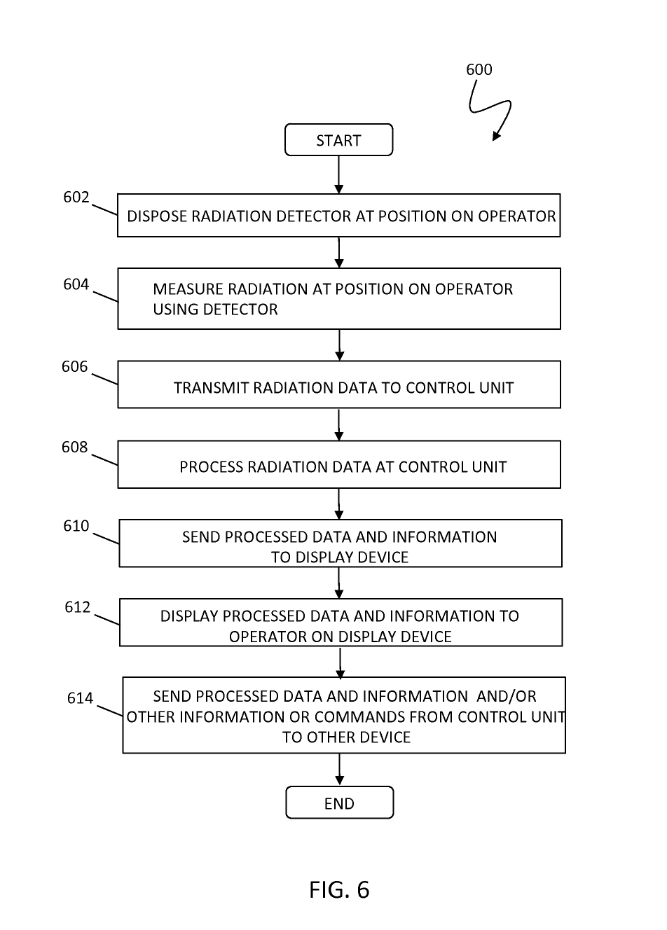

FIG. 6 is a flow diagram 600 showing a method for displaying radiation information and/or alerts to an operator according to an embodiment of the system described herein. As discussed herein, the processing of the flow diagram 600 may enable an operator to be informed of radiation information and/or alerts without requiring the operator to actively survey for radiation exposure. At a step 602, a radiation detector having features like that discussed elsewhere herein is positioned on an operator, for example, on a wrist, hand, or finger of the operator. After the step 602, at a step 604, radiation is measured at the position on the operator where the radiation detector is disposed. The radiation may be that emitted from a radiation emitting unit, such as a radiography exposure device and/or brachytherapy devices. After the step 604, at a step 606, radiation data measured by the radiation detector may be transmitted to a control unit having features like that discussed elsewhere herein.

After the step 606, at a step 608, the radiation data is processed at the control unit. In various embodiments, the control unit may combine radiation exposure rate values with data from an on-board clock to compute integrated (accumulated) radiation dose values, including over short periods of time (e.g., during individual operations) and well as over long periods of time (e.g., hourly, daily, weekly, monthly, quarterly, annual exposure). The control unit may combine radiation exposure rate values and integrated (accumulated) exposure values with on-board GPS data to permit evaluation of the spatial locations where radiation exposure is received. After the step 608, at a step 610, the processed data and/or information is sent or otherwise transmitted to a display device having features like that discussed elsewhere herein. In an embodiment, the control unit and the display device may be a combined unit and may be disposed on a head of the operator, such as in the form of smart glasses. As discussed elsewhere herein, radiation exposure rate values may be provided substantially continuously (i.e., nearly all the time the system is being used) irrespective of whether the values have exceeded any pre-set alarm thresholds. In addition, the control device may evaluate data to confirm whether the radiation detector is properly responding, so that the operator has a continuous indication that the equipment is operational.

In normal, non-hazard, operation, the operator would notice the radiation levels fluctuating within a normal range as the detector is move to different areas, consistent with fluctuating radiation levels that exist in most radiation related environments. Thus, absence of any fluctuation is an indicator to the operator that the equipment is not working properly, even if the measured ration rates do not exceed alarm levels. Note also that, in systems having the remote site 202 (discussed above), it is possible to ensure at the remote site 202 that the radiation detector(s) provide the expected fluctuations in the normal range to ensure that the operator is using the detector(s) properly and that the equipment is functioning properly.

After the step 610, at a step 612, the processed data and/or information is displayed to the operator on a display of the display device. After the step 612, at an optional step 614, the control unit may also send the processed data and/or information to another unit, such as another control unit, and/or send commands to another unit, such as to the radiation emitting unit. Specifically, at the optional step 614, the control unit may command the radiation emitting unit to move the source assembly thereof into a shielded position. After the step 614 (or after the step 612 if no optional step 614 is performed), processing is complete.

Various embodiments discussed herein may be combined with each other in appropriate combinations in connection with the system described herein. Additionally, in some instances, the order of steps in the flow diagrams, flowcharts and/or described flow processing may be modified, where appropriate. Further, various aspects of the system described herein may be implemented using software, hardware, a combination of software and hardware and/or other computer-implemented modules or devices having the described features and performing the described functions. The system may further include additional displays and/or other computing or electronic components for providing a suitable interface with a user and/or with other computers.

Software implementations of aspects of the system described herein may include executable code that is stored in a computer-readable medium and executed by one or more processors. The computer-readable medium may include volatile memory and/or non-volatile memory, and may include, for example, a computer hard drive, ROM, RAM, flash memory, portable computer storage media such as a CD-ROM, a DVD-ROM, an SD card, a flash drive or other drive with, for example, a universal serial bus (USB) interface, and/or any other appropriate tangible or non-transitory computer-readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A radiation survey system, comprising:
a radiation detector that measures radiation substantially continuously;
a control unit that receives data from the radiation detector and processes the data; and
a display device that receives the processed data from the control unit and displays the processed data on a display substantially continuously to show radiation levels fluctuating within a normal range as the radiation detector is moved to different areas, wherein the display device is wearable or carryable by an operator.

2. The radiation survey system according to claim 1, wherein at least one of the following is provided: (i) the radiation detector is wearable or carryable by the operator, or (ii) the control unit is wearable or carryable by the operator.

3. The radiation survey system according to claim 1, wherein the control unit and the display device are combined into a single control/display unit.

4. The radiation survey system according to claim 3, wherein the single control display unit is wearable on a head or a wrist of the operator.

5. The radiation survey system according to claim 1, wherein the radiation detector, the control unit and the display device are integrated into a single integrated unit.

6. The radiation survey system according to claim 5, wherein the single integrated unit is wearable on a head or a wrist of the operator.

7. The radiation survey system according to claim 1, wherein the radiation detector is wearable on an arm, leg, wrist, ankle, or finger of an operator.

8. The radiation survey system according to claim 1, wherein the operator is presented with radiation information by the display device without the operator actively performing independent radiation survey actions.

9. The radiation survey system according to claim 1, further comprising:
a radiation emitting unit that emits the radiation detected by the radiation detector, wherein the radiation emitting unit includes an exposure device that is controllable by the control unit.

10. The radiation survey system according to claim 1, further comprising:
a remote site that receives control information from the radiation detector, wherein radiation detectable at the radiation detector is not directly detectable at the remote site.

11. The radiation survey system according to claim 1, wherein at least one of the following is further provided:
(i) wherein the radiation detector is a first radiation detector, and wherein the radiation survey system further comprises at least one second radiation detector;
(ii) wherein the control unit is a first control unit, and wherein the radiation survey system further comprises at least one second control unit; or
(iii) wherein the display device is a first display device, and wherein the radiation survey system further comprises at least one second display device.

12. A method of performing a radiation survey, comprising:
disposing a radiation detector at a position on an operator;
measuring radiation at the radiation detector;
receiving substantially continuously, at a control unit, data sent from the radiation detector;
processing the received data at the control unit;
receiving, at a display device, the processed data sent from the control unit; and
displaying the processed data to an operator on a display of the display unit substantially continuously to show radiation levels fluctuating within a normal range as the radiation detector is moved to different areas, wherein the display unit is worn or carried by the operator.

13. The method according to claim 12, wherein at least one of the following is further provided: (i) the radiation detector is worn or carried by the operator, or (ii) the control unit is worn or carried by the operator.

14. The method according to claim 12, wherein the control unit and the display device are combined into a single control/display unit.

15. The method according to claim 14, wherein the single control display unit is worn on a head or a wrist of the operator.

16. The method according to claim 12, wherein the radiation detector is wearable on an arm, leg, wrist, ankle, or finger of an operator.

17. The method according to claim 12, wherein the radiation detector, the control unit and the display device are integrated into a single integrated unit.

18. The method according to claim 17, wherein the single integrated unit is worn on a head or a wrist of the operator.

19. The method according to claim 18, further comprising:
detecting at the radiation detector the radiation emitted by a radiation emitting unit.

20. The method according to claim 19, wherein the radiation emitting unit includes an exposure device that is controlled by the control unit.

21. The method according to claim 12, further comprising:
a remote site receiving control information from the radiation detector, wherein radiation detectable at the radiation detector is not directly detectable at the remote site.

22. The method according to claim 12, wherein the operator is presented with radiation information by the display device without the operator actively performing independent radiation survey actions.
